(19) United States
(12) Patent Application Publication
(10) Pub. No.: US 2008/0092749 A1
(43) Pub. Date: Apr. 24, 2008

(54) Automatic vending machine for noodles

(76) Inventor: Kyoung-Duk Kim, Bucheon-si (KR)

Correspondence Address: Neil A DuChez;Renner Otto Boisselle & Sklar, 1621 Euclid Avenue, 19TH Floor, Cleveland, OH, 44115, US

(21) Appl. No.: 10/518,424

(22) PCT Filed: Jun. 17, 2003
(86) PCT No.: PCT/KR03/01181

§ 371 Date: Jul. 14, 2005

(30) Foreign Application Priority Data
Jun. 17, 2002 (KR) 10-2002-0033775
Jun. 17, 2002 (KR) 20-2002-0018316
Jun. 17, 2002 (KR) 20-2002-0018317
Jun. 17, 2002 (KR) 20-2002-0018318
Jun. 17, 2002 (KR) 20-2002-0018319
Jun. 18, 2002 (KR) 20-2002-0018402

(51) Int. Cl. A47J 27/14; A47J 36/00; G07F 13/00; G07F 13/10

(52) U.S. Cl. 99/329 P; 99/326

(57) ABSTRACT

Disclosed is an automatic vending machine for noodles, capable of sanitarily cooking them. The automatic vending machine for noodles comprises a discharging hole, which is formed at the door, and it is opened and closed by a discharging door. A coin machine and a door are installed at the inside of the main body. A metallic disposable vessel for holding the noodles and spices is stored in the inside of the noodle storing part. The disposable vessels are automatically released from the noodles storing part by means of the disposable vessel supplying part. The disposable vessels are transmitted to predetermined positions by means of the disposable vessel conveying part. The disposable vessels are automatically released from the main body through the discharging door by the disposable vessel discharging part. The control part controls operations of the constitutional elements of the automatic vending machine as described above.

### TECHNICAL FIELD

The present invention relates to an automatic vending machine for noodles, more particularly to an automatic vending machine for noodles capable of automatically cooking noodles and supplying a consumer with them on the basis of an ordering signal generated during insertion a coin into the automatic vending machine.

### BACKGROUND ART

Generally, an automatic vending machine for noodles typically includes an outlet for automatically discharging cup-type noodles on the basis of an ordering signal that is generated during insertion a coin into the automatic vending machine, and a hot-water outlet for pouring hot water into the cup-type noodles discharged through the noodles outlet.

A problem with the conventional automatic vending machine for noodles as described above is that only the cup-type noodles may be on sale due to its operating mechanism. Therefore, it is impossible to satisfy consumer's desire for eating noodles wrapped by a vinyl paper.

A variety of endeavors for solving this problem have been proposed. One approach, conventional automatic vending machines for cooking noodles wrapped by a vinyl paper, has been proposed.

Herein below, a procedure for cooking noodles wrapped by a vinyl paper will be briefly explained.

At first, if a consumer puts a coin into a coin-operated machine, an operational starting signal is generated and thereafter noodles wrapped by a vinyl paper, dressing material, and a hot-water are automatically charged into a cooking vessel. Then, the vessel is heated and thereby the noodles begin to be cooked. After cooking the noodles, they are poured into another vessel and then it may be exhausted from the vending machine to the outside through the outlet.

In the conventional automatic vending machine for noodles as described above, it is necessary to have a depository for loading a plurality of open cup-type noodles as a stack and a depository for loading a plurality of vessels for receiving cooked noodles. Accordingly, the manufacturing cost for the conventional automatic vending machine is increased due to an increase in number of constitutional elements. Also, the conventional automatic vending machine must be made in a large scale. Since the cooking vessel is washed by only sprayed water, it may be incompletely washed so that the sanitary conditions thereof are causing great anxiety.

In the meantime, another approach for solving foregoing problem has been proposed. That is, an automatic vending machine for noodles by directly heating a disposable vessel has been proposed. However, in this conventional automatic vending machine for noodles must have depositories for loading a plurality of open cup-type noodles, dressing material and a plurality of vessels. Accordingly, the manufacturing cost for the conventional automatic vending machine is also increased due to an increase in number of constitutional elements. Furthermore, the conventional automatic vending machine must be made in a large scale.

### DISCLOSURE OF INVENTION

Therefore, the present invention has been developed to solve the above-mentioned problems. It is an object of the present invention to provide an automatic vending machine for noodles capable of sanitarily cooking noodles by directly heating noodles contained in a disposable vessel.

It is another object of the present invention to provide an automatic vending machine for noodles of which a main body has a considerably reduced volume over previously known vending machines for noodles, by removing the necessity for employing depositories for loading a plurality of open cup-type noodles and dressing material, by removing the necessity for employing a vessel and a gas burner for cooking noodles.

In order to accomplish the above object, the present invention provides an automatic vending machine for noodles, which automatically cooks noodles by receiving an ordering signal when a predetermined coin is inserted into a coin-operated mechanism, characterized by comprising:

a main body having a door rotatably installed at an open front portion thereof, a middle partition and a lower partition which are installed in the main body and are parallel with each other therein, in which a discharging hole is formed through a one side of the door and may be open or closed by a discharging door, and in which a through hole is formed through a one side of the middle partition;

a noodles storing member for storing a plurality of metal disposable vessels therein being installed at an inner upper portion of the main body so that an open lower portion thereof is located above the through hole, in which noodles to be cooked and dressing materials are contained in the metal disposable vessels;

a vessel supplying part for discharging the metal disposable vessels loaded in the noodles storing member one by one being is installed at the central partition so that it is located between the through hole and the noodles storing member;

a vessel conveying part for transferring the metal disposable vessels being installed at the lower partition, in which the vessel conveying part transfers the metal disposable vessel, which is discharged from the vessel supplying part, from an initial position to a heating position, which is set on an upper surface of the heating member, when noodles has been cooked by pouring a hot-water into the metal disposable vessel and by directly heating the metal disposable vessel using the heating member, the vessel conveying part transfers the metal disposable vessel from the heating position to an exhausting position;

a vessel discharging part for discharging the metal disposable vessel, which is transferred to the exhausting position due to operation of the vessel conveying part, to the outside through the discharging hole of the discharging door, the vessel discharging part 80 being installed at a front portion of the vessel conveying part; and

a control part for controlling the vessel supplying part, the vessel conveying part, the hot-water supplying part, the heating member and the vessel discharging part by receiving sensing signals generated from sensing means which senses operational states of the vessel supplying part, the vessel conveying part and the vessel discharging part and senses the temperature of the hot-water supplied from the hot-water supplying part.

Preferably, the hot-water supplying part is installed in the main body. The hot-water supplying part comprises as follows:

a storage tank for storing water supplied from an outer water source;

a heating tank for heating water introduced from the storage tank;

a first valve for controlling introduction of water from the storage tank to the heating tank being installed between the storage tank and the heating tank;

a plurality of water level sensing sensor for repeatedly sensing the level of water supplied from the storage tank being installed in the heating tank;

a hot-water heating member for heating water supplied from the storage tank being installed in the heating tank;

a temperature sensing sensor for sensing the temperature of water heated by the heating tank; and

a second valve for controlling discharge of hot-water heated by the hot-water heating member into the metal disposable vessel located on the heating member, the second valve being controlled by the control part.

The vessel supplying part comprises as follows:

a link-operating part including a pair of vessel-supporting links, a pair of connecting links, a reciprocating link, and a first horizontal guiding member, in which ends of the vessel-supporting links are hingedly coupled with both sides of the first bracket installed at the middle partition, both ends of the disposable vessel are located over the vessel-supporting links, the ends of the connecting links are hingedly connected with the vessel-supporting links, the other ends of the connecting links are hingedly connected with both sides of the reciprocating link, the first horizontal guiding member for guiding the reciprocating link in order to slide the reciprocating link in the horizontal direction is installed at the middle partition;

a discharging part for operating the link-operating part including a second connecting rods, a second rotating plate, and a second driving member, in which one end of the second connecting rods is coupled with the reciprocating link, the other end of the second connecting rods is coupled with the second rotating plate and the center thereof is eccentric to the second rotating plate, the second rotating plate is installed at the middle partition by means of a third bracket, the second driving member for driving the second rotating plate is installed at the third bracket and is controlled by the control part; and

a vessel-supporting part including a discharging supporting bracket, a vessel-locating member, a first connecting rod, a first rotating rod, a first rotating plate, and a first driving member, in which the discharging supporting bracket is installed at the lower partition so that it is located below the lower portion of the through hole, the vessel-locating member can slide through a space created between the legs of the vessel-supporting link upwards and downwards by a vertical guiding member, the vertical guiding member is installed in the discharging supporting bracket, in which one end of the first connecting rod is connected with the vessel-locating member, the other end of the first connecting rod is connected with one end of the first rotating rod, the first driving member for driving the first rotating plate in order to move the vessel-locating member in the vertical direction is installed at the lower partition and is controlled by the control part.

The vessel conveying part comprises as follows:

a pair of link members having lower ends hingedly coupled with a pair of fourth brackets, respectively, in which the fourth brackets are installed on the upper surface of the lower partition so that they are located at the lower part of the through hole;

a vessel-supporting member having an open one side and lower sides hingedly coupled with the upper ends of the link members, in which the edge of the disposable vessel transferred from the vessel supplying part is snugly seated thereon and then it is supported

a vessel transferring driving part including a third connecting rods, a second rotating rod, a third rotating plate and a third driving member, in which one end of the third connecting rods is coupled with the link member, the other end of the third connecting rods is coupled with on end of the second rotating rod, the other end of the second rotating rod is coupled with the third rotating plate, in which the third driving member is installed at the lower partition by means of the fifth bracket, the third driving member operates the second rotating rod in order to move the vessel-supporting member from the initial position to the heating position, from the heating position to the discharging position, and from the discharging position to the initial position, with maintaining the horizontal state of the vessel-supporting member.

The vessel discharging part comprises as follows:

a second horizontal guiding member being installed at an upper portion of a sixth bracket, in which the sixth bracket is installed at a front part of the lower partition so that it is located at the lower portion of the exhausting position;

a vessel-discharging member being installed on an upper surface of the second horizontal guiding member, in which the metal disposable vessel transferred to the exhausting position due to operation of the vessel conveying part may be seated on the vessel-discharging member;

a fourth rotating plate being rotatably coupled with one end of a fifth connecting rod of which the other end is rotatably coupled with the vessel discharging member; and

a fourth driving member for moving the fourth rotating plate being installed at a one side of the sixth bracket and being controlled by the control part, in which the vessel discharging member moves toward the discharging hole of the discharging door with maintaining its horizontal state due to movement of the fourth rotating plate driven by the fourth driving member.

### BRIEF DESCRIPTION OF DRAWINGS

FIG. 1 is an exploded perspective view of an automatic vending machine for noodles according to a preferred embodiment of the present invention;

FIG. 2 is a perspective view of the automatic vending machine for noodles shown in FIG. 1, showing an assembled state thereof;

FIG. 3 is a front view of the automatic vending machine for noodles shown in FIG. 1, showing the assembled state thereof;

FIG. 4 is a partial side view of the automatic vending machine for noodles shown in FIG. 1, showing the assembled state thereof;

FIG. 5a is a top plan view of a vessel-supporting part as shown in FIG. 2, showing the operational state thereof;

FIG. 5b is a side view of the vessel-supporting part as shown in FIG. 2, showing the operational state thereof;

FIGS. 5c to 5e are schematic views of the vessel supplying part as shown in FIG. 1, showing systematically the operational state thereof;

FIG. 6a is a top plan view of the vessel conveying part as shown in FIG. 1, showing the operational state thereof;

FIG. 6b is a side view of the vessel conveying part as shown in FIG. 1, showing the operational state thereof;

FIG. 7a is a top plan view of the vessel discharging part as shown in FIG. 1, showing an operational state thereof;

FIG. 7b is a side view of the vessel discharging part as shown in FIG. 1, showing an operational state thereof;

FIG. 8 is a schematic view for illustrating a hot-water supplying part of the automatic vending machine for noodles according to the preferred embodiment of the present invention;

FIG. 9a is a side view for showing another embodiment of a vertical guiding member according to the preferred embodiment of the present invention;

FIG. 9b is a side view for showing another embodiment of the first horizontal guiding member according to the preferred embodiment of the present invention;

FIG. 9c is a side view for showing another embodiment of the second horizontal guiding member according to the preferred embodiment of the present invention;

FIG. 10 is an enlarged view, partly in cross section, of chopsticks discharging part according to the preferred embodiment of the present invention;

FIG. 11 is a sectional view of another chopsticks discharging part according to the preferred embodiment of the present invention; and

FIG. 12 is a schematic block diagram for illustrating a control part according to the preferred embodiment of the present invention.

### BEST MODE FOR CARRYING OUT THE INVENTION

### EMBODIMENTS

Hereinafter, the automatic vending machine for noodles according to the preferred embodiment of the present invention will be described in detail with reference to the accompanying drawings.

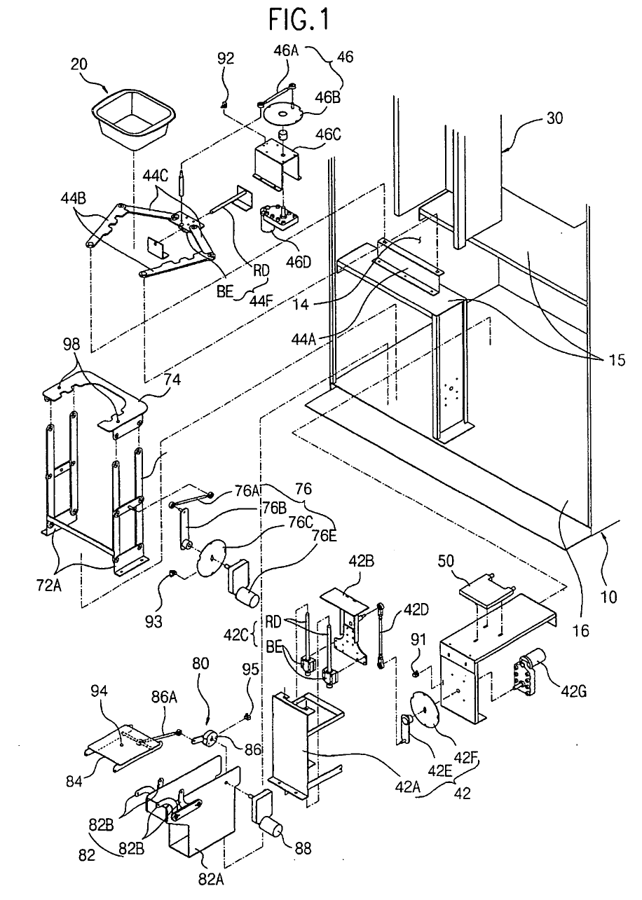

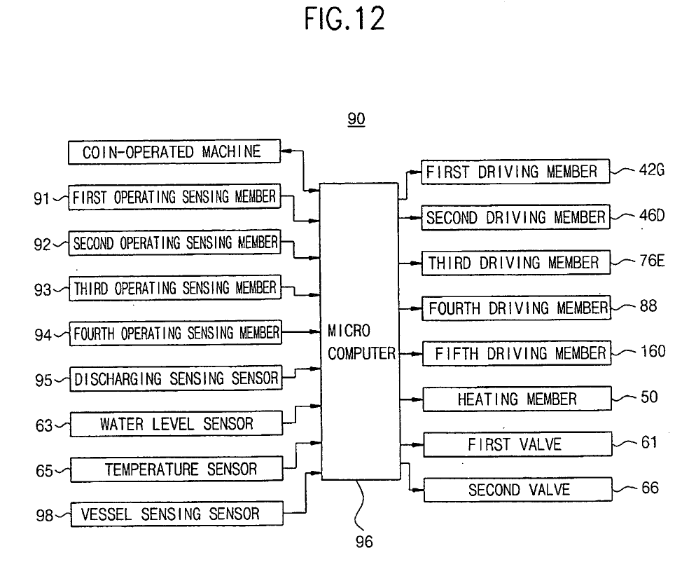

The automatic vending machine for noodles according to the preferred embodiment of the present invention is shown in FIG. 1. The automatic vending machine comprises a main body 10 having a coin-operated mechanism (not shown), a noodles storing member 30, a vessel supplying part 40, a vessel conveying part 70, a vessel discharging part 80 and a control part 90 (referred to FIG. 12). In the automatic vending machine for noodles as shown in FIG. 1, a disposable vessel 20 is loaded in the noodles storing member 30. The vessel supplying part 40 exhausts the disposable vessel 20 for containing noodles from the noodles storing member 30 one by one. When the disposable vessel 20 is transmitted to a heating member 50, a hot-water transmitted from a hot-water supplying part 60 is poured into the disposable vessel 20 and then noodles contained in the disposable vessel 20 begins to be cooked. After cooking the noodles, the disposable vessel 20 is transferred to an exhausting position (C) due to operation of the vessel conveying part 70. The disposable vessel 20 transferred by the vessel conveying part 70 is exhausted from the automatic vending machine due to operation of the vessel discharging part 80. The control part 90 (referred to FIG. 12) controls constitutional elements of the vending machine as described above.

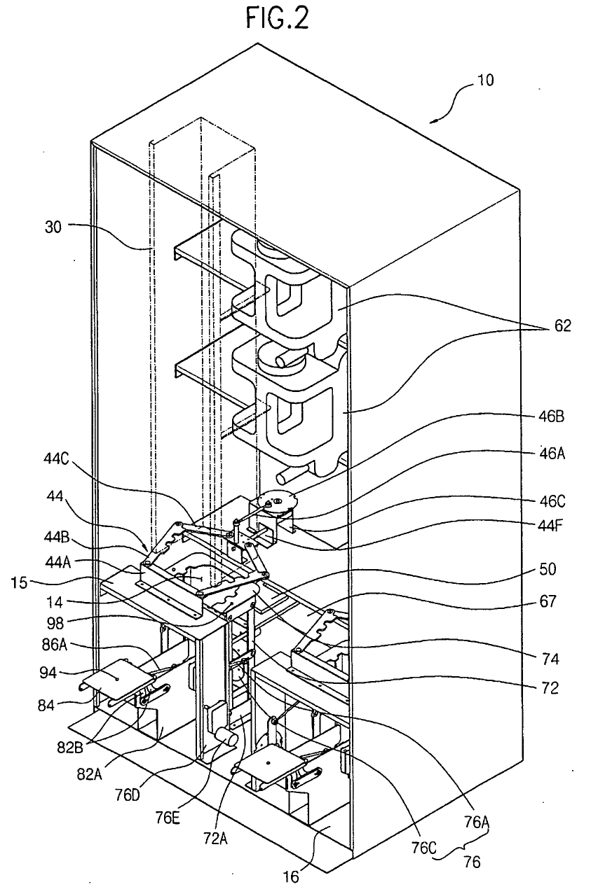

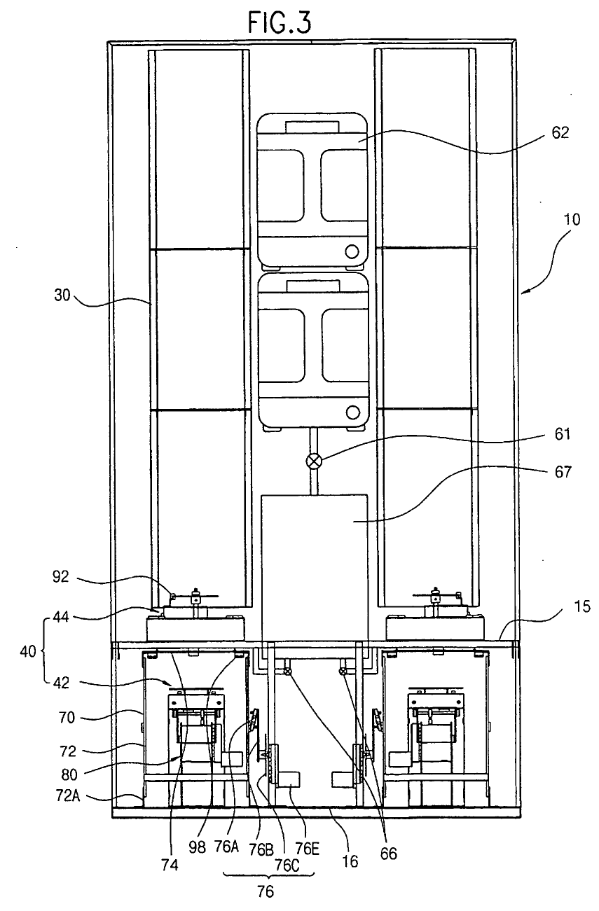

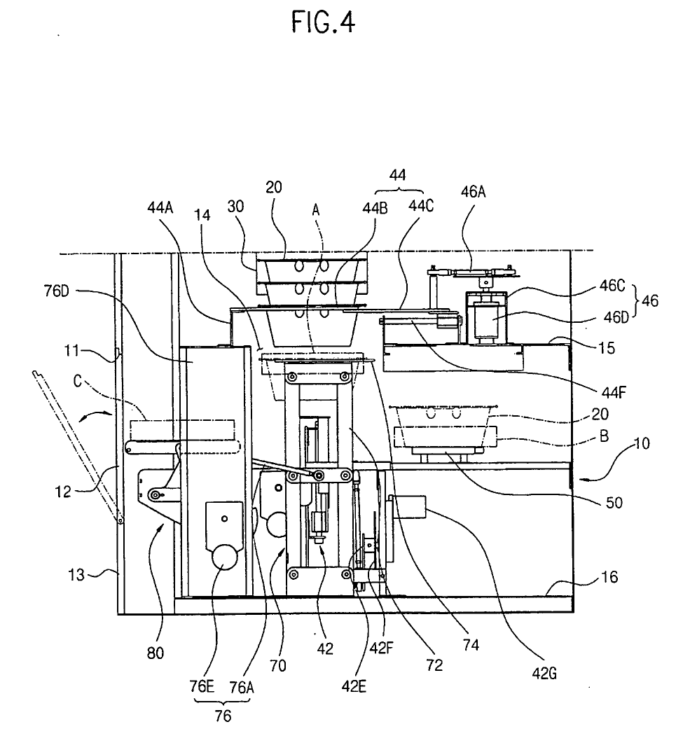

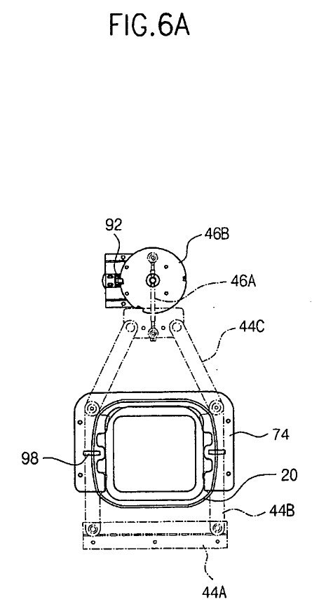

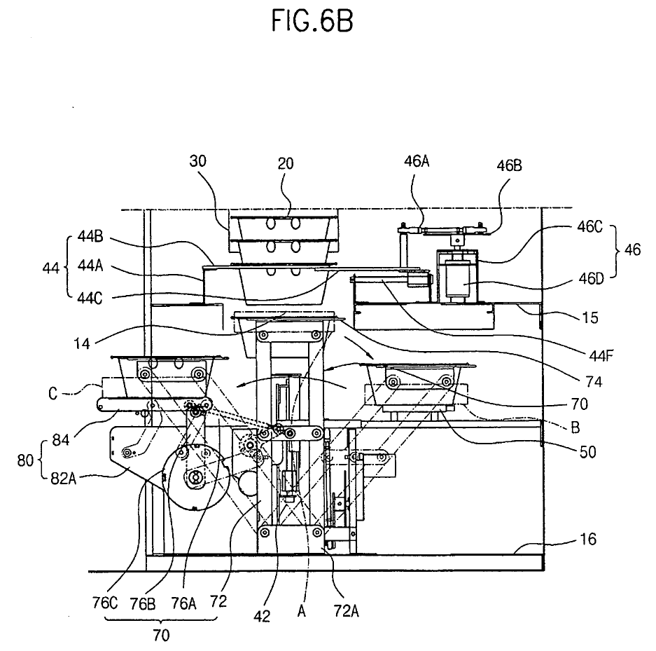

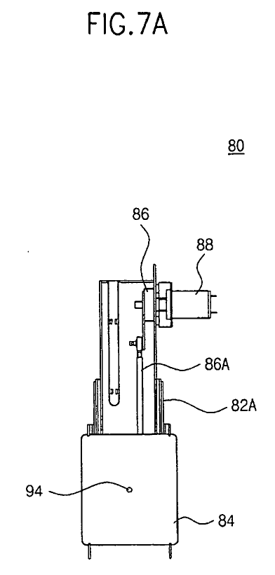

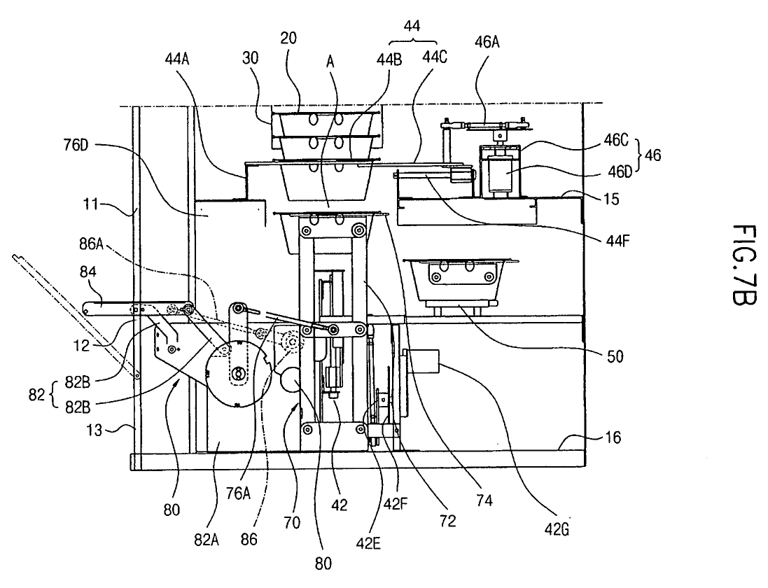

Having described the automatic vending machine for noodles according to the preferred embodiment of the present invention in detail, constitution and operation thereof can be understood as follows with reference drawings FIGS. 2 to 7b.

A door 13 is installed at a front surface of the main body 10. The coin-operated mechanism (not shown) for generating a coin-charging signal is installed at a rear surface of the main body 10. A lower partition 16 and a middle partition 15 are installed in an interior of the main body 10 and they are parallel with each other. A through hole 14 is formed through a one side of the middle partition 15. Also, a discharging hole 11 is formed through a one side of the door 13. A discharging door 12 is installed at the discharging hole 11 and it can pivot about a hinge axis fixed at a lower end of the discharging door 12. A torsion spring (not shown) is installed at a position adjacent to the hinge axis fixed at the lower end of the discharging door 12. The torsion spring may push the discharging door 12 so as to close the discharging hole 11.

The noodles storing member 30 for storing noodles is provided with an open lower portion and a front surface, which is open and closed by the door (not shown). A metallic disposable vessel 20 having noodles and dressing materials therein is loaded and contained in the noodles storing member 30. The noodles storing member 30 is spaced from an upper surface of the middle partition 15 at a predetermined distance. At this time, the open lower portion is positioned at the upper portion of the through hole 14 of the middle partition 15.

The vessel supplying part 40 for discharging the disposable vessel 20 loaded in the noodles storing member 30 one by one comprises a vessel-supporting part 42, a link-operating part 44 and a discharging part 46.

The vessel-supporting part 42 includes a vessel-locating member 42B, a first connecting rod 42D, a first rotating rod 42E, a first rotating plate 42F, and a first driving member 42G. The vessel-locating member 42B can slide in a discharging supporting bracket 42A upwards and downwards with the aid of a vertical guiding member 42C. The vertical guiding member 42C is installed in the discharging supporting bracket 42A, which is installed at the lower partition 16 so that it is located at the lower portion of the through hole 14 of the middle partition 15. One end of the first connecting rod 42D is connected with the vessel-locating member 42B. The other end of the first connecting rod 42D is connected with one end of the first rotating rod 42E. The first driving member 42G for driving the first rotating plate 42F in order to move the vessel-locating member 42B in the vertical direction is installed at the lower partition 16 and is controlled by the control part 90. Accordingly, when the first driving member 42G begins to be operated, the first rotating rod 42E is rotated about the rotating shaft of the first driving member 42G and thereby the first rotating plate 42F and the first connecting rod 42D are rotated together.

Alternatively, the other end of the first connecting rod 42D can be directly connected with the first rotating plate 42F in a state that the center thereof is eccentric to the center of the first rotating plate 42F. Furthermore, the first rotating plate 42F can be rotated due to operation of the first driving member 42G.

The link-operating part 44 comprises a pair of vessel-supporting links 44B, a pair of connecting links 44C, a reciprocating link 44D, and a first horizontal guiding member 44F. The ends of the vessel-supporting links 44B are hingedly coupled with both sides of the first bracket 44A installed at the middle partition 15. Both ends of the disposable vessel 20 are located over the vessel-supporting links 44B. The ends of the connecting links 44C are hingedly connected with the vessel-supporting links 44B. The other ends of the connecting links 44C are hingedly connected with both sides of the reciprocating link 44D. The first horizontal guiding member 44F for guiding the reciprocating link 44D in order to slide the reciprocating link 44D in the horizontal direction is installed at the middle partition 15. The first horizontal guiding member 44F supports the edges of the disposable vessel 20 and then it is operated in conjunction with the vessel-supporting part 42 in order to discharge the disposable vessel 20 one by one.

As shown in FIG. 1, the vertical-guiding member 42C and the first horizontal guiding member 44F comprise a cylindrical bearing (BE) and guiding rods (RD), respectively. The bearing (BE) is combined with the vessel-locating member 42B. The guiding rods (RD) pass through the bearing (BE) and upper and lower ends of the guiding rods (RD) are installed at upper and the lower portion of the discharging supporting bracket 42A.

Accordingly, because the bearing (BE) and the guiding rods (RD) are engaged with each other and can slide together, the vessel-locating member 42B combined with the bearing (BE) can move in the vertical direction during operation of the first driving member 42G and the reciprocating link 44D can slide in the horizontal direction.

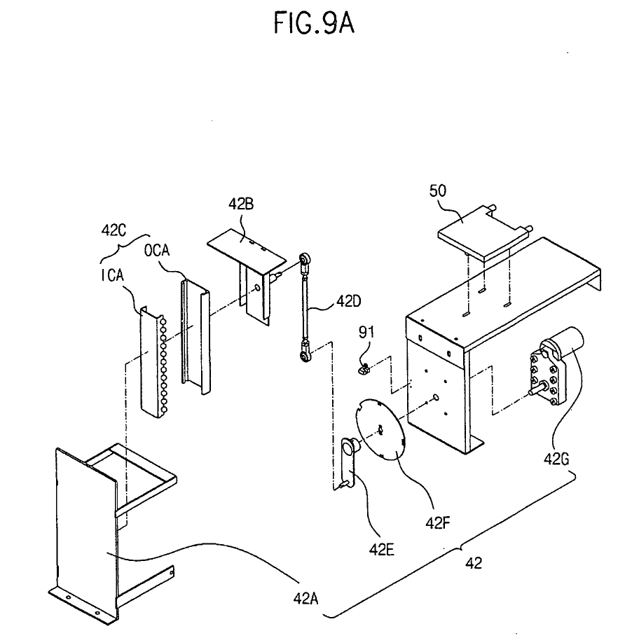

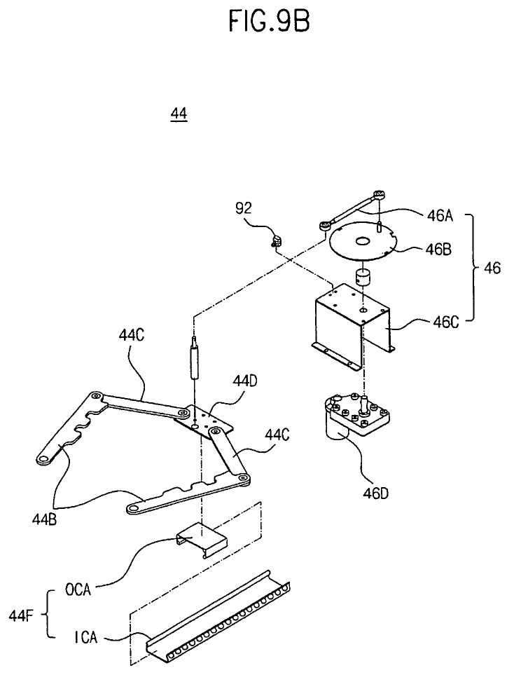

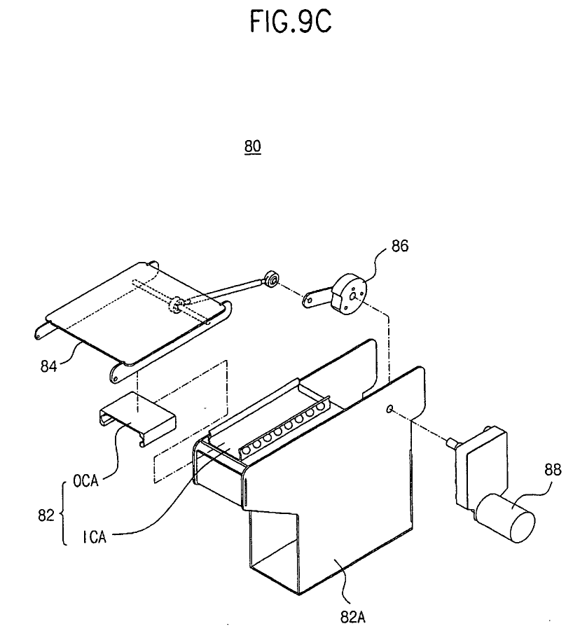

As shown in FIG. 9a, the vertical-guiding member 42C according to another embodiment of the present invention comprises an outer case (OCA) and an internal case (ICA). The outer case (OCA) is vertical installed at the discharging supporting bracket 42A. The internal case (ICA) can slide in the longitudinal direction by a plurality of bearings received in the outer case (OCA) and the vessel-locating member 42B is installed therein.

As shown in FIG. 9b, the horizontal-guiding member 44F according to another embodiment of the present invention comprises an internal case (ICA) and an outer case (OCA). The internal case (ICA) is installed at the lower surface of the reciprocating link 44D. Pluralities of ball bearings are installed in the outer case (OCA) and both ends of the outer case (OCA) are installed a pair of second brackets 44E.

However, the structures of the vertical-guiding member 42C and the horizontal-guiding member 44F are not limited within the structure according to the embodiments as described above. In other words, all structures for guiding the vessel-locating member 42B in the vertical direction and for guiding the reciprocating link 44D in the horizontal direction can be employed in the present invention.

The discharging part 46 for operating the link-operating part 44 comprises a second connecting rods 46A, a second rotating plate 46B, and a second driving member 46D. One end of the second connecting rods 46A is coupled with the reciprocating link 44D. The other end of the second connecting rods 46A is coupled with the second rotating plate 46B and the center thereof is eccentric to the second rotating plate 46B. The second rotating plate 46B is installed at the middle partition 15 by means of a third bracket 46C. The second driving member 46D for driving the second rotating plate 46B is installed at the third bracket 46C and is controlled by the control part 90.

In the vessel supplying part 40 having the structure as described above, the link-operating part 44 and the vessel-supporting part 42 are operated in conjunction with each other and then the disposable vessel 20 may be discharged one by one.

The heating member 50 is installed on an upper surface of the bracket extending from a fifth bracket 76D, which will be explained in below, so that it may be located at a heating position (B). The heating member 50 has a structure in which a heating wire is inserted into a metal having excellent heat conductivity such as aluminum. The hot-water supplying part 60 uniformly maintains the temperature of the water at a predetermined temperature and then supplies a predetermined quantity of hot water for the disposable vessel 20 located on the heating member 50.

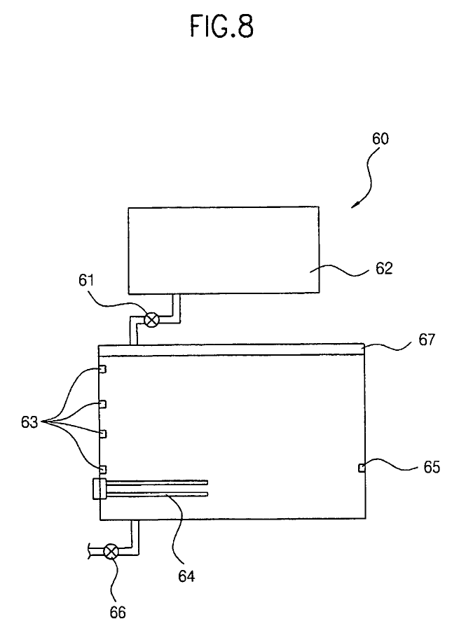

As shown in FIG. 8, the heating member 50 comprises a storage tank 62 having a first valve 61, a plurality of water-level sensing sensors 63, a hot-water heating member 64, a temperature-sensing sensor 65, and a heating tank 67 having a second valve 66. The first valve 61 is installed in the main body 10 and is controlled by the control part 90. The water-level sensing sensors 63 for repeatedly sensing the level of water supplied from the storage tank 62 are installed at an inner wall of the main body 10 in a state that they are not hindered with the noodles storing member 30. The hot-water heating member 64 for heating supplied water is installed in the heating tank 67. The temperature-sensing sensor 65 for sensing the temperature of the heated water is installed in the heating tank 67. The second valve 66 is controlled by the control part 90 so as to supply the disposable vessel 20 located on the heating member 50 with heated water. Although, the hot-water heating member 64 may be an exothermic lamp, a heating wire, etc., the heating wire is employed in the embodiment according to the present invention.

At this time, if the storage tank 62 is located above the heating tank 67, water can be supplied into the heating tank 67 by only opening the first valve. However, if the storage tank 62 is located below the heating tank 67, water only may be supplied into the heating tank 67 by operating a certain pump.

In the meantime, the water-level sensing sensors 63 sense water level at a lower portion, a middle portion and an upper portion within the heating tank 67, respectively. Accordingly, the control part 90 controls the quantity of the discharged hot water and the supplied water on the basis of sensing signal generated from the water-level sensing sensors 63.

The vessel conveying part 70 comprises a link member 72, a vessel-supporting member 74 and a vessel transferring driving part 76. The vessel conveying part 70 transfers the disposable vessel 20, which is discharged from the vessel supplying part 40, from the initial position (A) to the heating position (B) on the upper surface of the heating member 50. When a hot-water supplied by the hot-water supplying part 60 is poured into the disposable vessel 20 and then the disposable vessel 20 is directly heated by the heating member 50 and thereby noodles has been cooked, then the vessel conveying part 70 transfers the disposable vessel 20 from the heating position (B) to the exhausting position (C).

Lower ends of the link member 72 are hingedly coupled with a pair of fourth brackets 72A, respectively. The fourth brackets 72A are installed on the upper surface of the lower partition 16 so that they are located at a lower portion of the through hole 14.

One side of the vessel-supporting member 74, which is a front side for discharging the disposable vessel 20, is open so that the edge of the disposable vessel 20 is snugly seated thereon and then it is supported thereby during descend of the vessel-locating member 42B of the vessel supplying part 40. The upper ends of the link members 72 are hingedly coupled with both sides of the lower surface of the vessel-supporting member 74. Accordingly, when the link member 72 is rotated about the hinge position of the fourth bracket 72A in the forward and backward direction (=the direction toward the interior of the main body and opposite direction thereto), the vessel-supporting member 74 maintains its horizontal state and then it is moved toward the initial position (A), the heating position (B) and the exhausting position (C).

The vessel transferring driving part 76 comprises a third connecting rods 76A, a second rotating rod 76B, a third rotating plate 76C and a third driving member 76E. One end of the third connecting rods 76A is coupled with the link member 72. The other end of the third connecting rods 76A is coupled with the second rotating rod 76B. The second rotating rod 76B is installed at the third rotating plate 76C. The third driving member 76E for driving the third rotating plate 76C is controlled by the control part 90.

The vessel transferring driving part 76 as described above transfers the vessel-supporting member 74 from the initial position (A) to the heating position (B) by operating the link member 72 in the forward and backward direction, and then transfers it from the heating position (B) to the exhausting position (C), and finally transfers it from the exhausting position (C) to the initial position (A). During this transportation, the vessel-supporting member 74 may be transferred with maintaining its horizontal state.

The vessel-supporting member 74 of the vessel conveying part 70 may have a structure, which is the same as that of the first horizontal guiding member 44F. However, in this case, it is necessary to have any mechanical structure for downwardly moving the vessel conveying part 70 transferred in the horizontal direction in order to locate it on the upper surface of the heating member 50 at the heating position (B). Otherwise, it is necessary to having any structure for upwardly moving the heating member 50. Accordingly, it is preferable to have the link structure as described above in order to accurately operate the vessel conveying part 70.

The vessel discharging part 80 comprises a second horizontal guiding member 82, a vessel discharging member 84, a fourth rotating plate 86 and a fourth driving member 88. The vessel discharging part 80 transfers the disposable vessel 20, which is transferred to the discharging position (C) by means of the vessel conveying part 70, to the outside through the discharging hole 11 of the door 12.

As shown in FIG. 1, the second horizontal guiding member 82 comprises two pair of discharging link member 82B. Low ends of the discharging link members 82B are hingedly coupled with both upper sides of a sixth bracket 82A installed at a front portion of the lower partition 16 so that it may be located at the lower portion of the discharging position (C).

The discharging link member 82B transfers the vessel-discharging member 84 along a circular arc-shaped trace in a state that the upper ends of the discharging link member 82B are hingedly coupled with the both lower sides of the vessel-discharging member 84. At this time, the vessel-discharging member 84 maintains its horizontal state.

However, the second horizontal-guiding member 82 is not limited by the structure of the discharging link member 82B. As shown in FIG. 9c, the second horizontal-guiding member 82 can have a structure of which ball bearings (not shown) for sliding it are disposed therein. In other words, the second horizontal-guiding member 82 may comprise an outer case 82C fixed to the upper surface of the sixth bracket 82A, and an outer case 82D which slides in the longitudinal direction by means of a plurality of ball bearings received in the outer case 82C. Accordingly, if the vessel discharging member 84 is moved after fixing the outer case 82C to the upper surface of the sixth bracket 82A and fixing the vessel discharging member 84 to the outer case 82D, the vessel discharging member 84 can move in the horizontal direction due to sliding movement of the outer case 82D by means of the ball bearings.

In the vessel discharging member 84 having a shape for receiving the disposable vessel 20 transferred by the vessel conveying part 70, upper ends of the discharging link members 82B installed at the sixth bracket 82A are coupled with lower both sides of the vessel discharging member 84. A horizontal bar is installed at the lower surface of the vessel-discharging member 84. One end of the fifth connecting rod 86A is rotatably coupled with the horizontal bar.

The other end of the fifth connecting rod 86A is rotatably coupled with the fourth rotating plate 86. The fourth rotating plate 86 is installed at one side of the sixth bracket 82A so that the fourth driving member 88 drives the fourth rotating plate 86.

When the fourth rotating plate 86 installed at the sixth bracket 82A make the fourth rotating plate 86 to operate, the vessel-discharging member 84 moves along the circular arc trace by means of the fifth connecting rod 86A.

As shown in FIG. 12, the control part 90 includes sensing means for sensing whether the vessel supplying part 40, the vessel conveying part 70 and the vessel discharging part 80 are operated or not, and for sensing the temperature of the hot-water supplied from the hot-water supplying part 60. The control part 90 controls operations of the vessel supplying part 40, the vessel conveying part 70, hot-water supplying part 60 and the vessel discharging part 80 on the basis of sensing signal generated from the sensing means.

The control part 90 comprises a first operating sensing member 91 for sensing operation of the vessel-locating member 42B, a second operating sensing member 92 for sensing operation of the vessel-supporting link 44B, a vessel locating sensing sensor 98, a third operating sensing member 93 for sensing operation of the vessel-supporting member 74, a exhausting position sensing sensor 94, a fourth operating sensing member 95 for sensing operation of the vessel discharging member 84 and a microcomputer 96.

At this time, the first, the second, the third and the fourth operating sensing members 91,92,93,95 comprises a limit switch, respectively.

Herein below, constitution and operation of the operating sensing members 91,92,93,95 will be explained in detail.

The first operating sensing member 91, which is a limit switch, is installed at one side of the upper surface of the discharging supporting bracket 42A and is turned off or turned on in accordance with the reciprocating movement of the vessel-locating member 42B in the vertical direction and whereby it sense an operation of the vessel-locating member 42B. Likewise, the second operating sensing member 92 is installed at the third bracket 46C and is turned off or turned on in accordance with the reciprocating movement of the reciprocating link 44D and whereby it sense an operation of the vessel-supporting member 44B. Also, the third operating sensing member 93 is installed at the fifth bracket 76D and is turned off or turned on in accordance with the reciprocating movement of the second rotating rod 76B and whereby it sense an operation of the vessel-supporting member 74. The fourth operating sensing member 95 is installed at the sixth bracket 82A and is turned off or turned on in accordance with the reciprocating movement of the second horizontal guiding member 82 and whereby it sense an operation of the vessel discharging member 84.

Meanwhile, the first, the second, the third and the fourth operating sensing members 91,92,93,95 comprises a photo coupler (not shown), respectively for sensing a rotating angle or the number of rotation of the first, the second, the third and the fourth rotating plates 42F, 46B, 76C, 86.

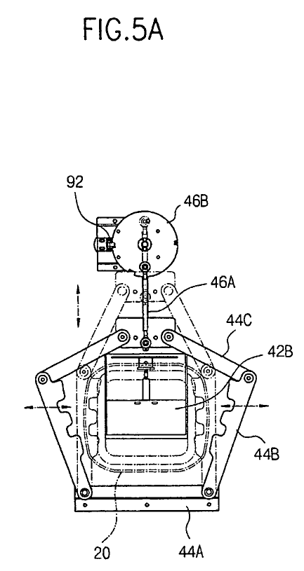

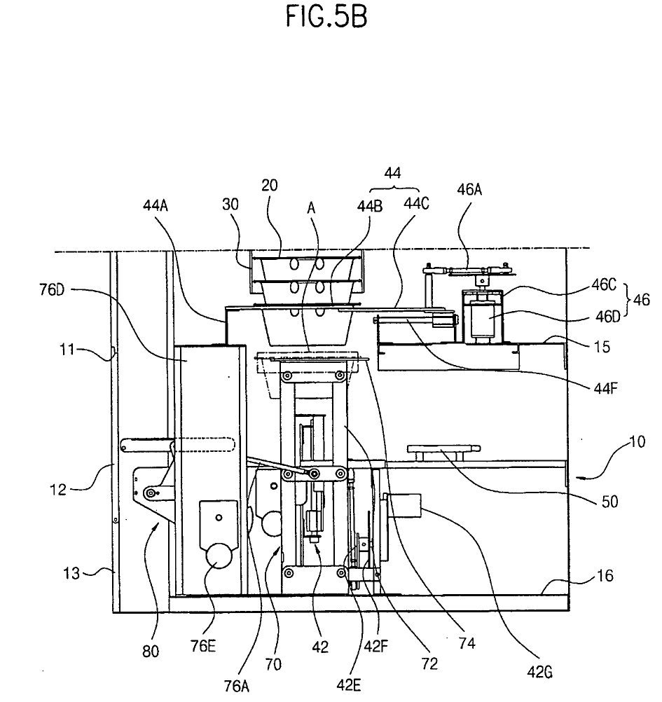

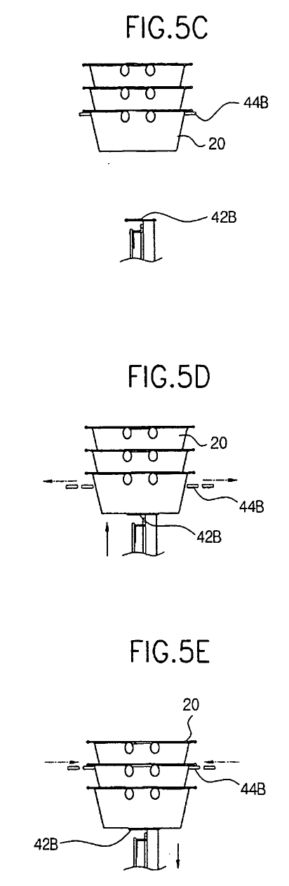

As shown in FIGS. 5a to 7b, sensing holes are formed through the first, the second, the third and the fourth rotating plates 42F, 46B, 76C, 86 and thereby the photo coupler can sense the rotating angle or the number of rotation through the sensing holes.

In other words, the photo coupler respectively senses the sensing holes formed through the first, the second, the third and the fourth rotating plates 42F, 46B, 76C, 86 at various positions and then it sends a sensing signal to the microcomputer 96 after sensing the rotating angle or the number of rotation. Then, the microcomputer 96 controls driving members for driving the rotating plates on the basis of the sensing signal. According to the preferred embodiment of the present invention, the first, the second, the third and the fourth rotating plates 42F, 46B, 76C, 86 rotates at 90°, 180°, 360° in accordance with an operating characteristic thereof.

Preferably, the vessel locating sensing sensor 98 comprises a limit switch. This vessel locating sensing sensor 98 is turned-on when it is pressed down by both side edges of the disposable vessel 20 to be seated. Alternatively, the vessel locating sensing sensor 98 is turned-off when the disposable vessel 20 is released from thereon.

Because the vessel locating sensing sensors 98 are installed at both side surfaces of the vessel-supporting member 74, it can sense a stable location of the disposable vessel 20 such that edges of the disposable vessel 20 locates on edges of the vessel-supporting member 74 and also can sense an instable location of the disposable vessel 20 such that the disposable vessel 20 locates on edges of the vessel-supporting member 74, and then makes next operation to stop. If the disposable vessel 20 locates on edges of the vessel-supporting member 74, the vessel locating sensing sensors 98 make the vending machine for noodles to stop and thereby it can prevent any accident from being generated. That is, the control part 90 controls the third driving member 76E when all of the vessels locating sensing sensors 98 are turned-on or turned-off. When all of the vessels locating sensing sensors 98 are turned-on or turned-off by means of the disposable vessel 20, they sense the stable of disposable vessel 20 and then next operation may be preceded.

As shown in FIG. 1, the exhausting position sensing sensor 94 is installed at the center of the vessel-discharging member 84 and senses the stable loading of the disposable vessel 20 when the edges of the disposable vessel 20 are contacted with the vessel-discharging member 84. Although the exhausting position sensing sensor 94 comprises a limit switch, any sensing means for sensing the stable loading of the disposable vessel 20 can be substituted with it.

As shown in FIG. 12, the microcomputer 96 controls operations of the first driving member 42G, the second driving member 46D, the third driving member 76E and the fourth driving member 88 by receiving sensing signals generated from the first, the second, the third and the fourth operating sensing sensors 91,92,93,95, the vessel locating sensing sensor 98, the exhausting position sensing sensor 94, the water level sensing sensor 93 and the temperature sensing sensor 65. Also, the microcomputer 96 controls operation of the first and the second valves 61,66.

Herein below, operation of the microcomputer 96 will be explained in detail.

The microcomputer 96 applies an electric power to the first driving member 42G when a coin-inserting signal is generated from a coin-operated mechanism (not shown). Then, the disposable vessels 20 are moved upwards due to ascending of the vessel locating member 42B. When the first operating sensing member 91 senses an operation of the vessel-locating member 42B, the microcomputer 96 applies an electric power to the second driving member 46D in order to widen the space between the legs of the vessel-supporting link 44B. When the second operating sensing member 92 senses an operation of the vessel-supporting link 44B, the microcomputer 96 applies an electric power to the first driving member 42G in order to downwardly move and then to stop the vessel-locating member 42B. Then, the microcomputer 96 applies an electric power to the second driving member 46D in order to return the vessel-supporting link 44B to its initial position so that next disposable vessel 20 is locked in the vessel-supporting link 44B. When the second operating sensing member 92 senses the operation of the vessel-supporting link 44B, the microcomputer 96 applies an electric power to the first driving member 42G in order to downwardly move the vessel-locating member 42B to its initial position. As a result, the primary disposable vessel 20 is located on the vessel-supporting member 74. When the vessel locating sensing sensor 98 senses a stable loading of the disposable vessel 20, the microcomputer 96 applies an electric power to the first driving member 92F in order to return the vessel-locating member 92B to its initial position. Then, the microcomputer 96 applies an electric power to the third driving member 76E in order to move the vessel-supporting member 74 from the initial position (A) to the heating position (B). When the third operating sensing sensor 93 senses an operation of the vessel-supporting member 74, the microcomputer 96 applies an electric power to the second valve 66 in order to open it for a predetermined time interval. When a predetermined quantity of hot water is poured into the disposable vessel 20, the microcomputer 96 applies an electric power to the heating member 50 for a predetermined time interval in order to heat the disposable vessel 20. After passing the predetermined time interval, the microcomputer 96 applies an electric power to the third driving member 76E in order to move the disposable vessel 20 from the heating position (B) to the exhausting position (C) and to return its initial position by means of the vessel-supporting member 74 in a state that the disposable vessel 20 maintains its horizontal state. When the exhausting position sensing sensor 94 senses a stable loading of the disposable vessel 20, the microcomputer 96 applies an electric power to the fourth driving member 88 in order to move the vessel-discharging member 84 toward the discharging hole 11. As a result, the vessel-discharging member 84 pushes the discharging door 12 outwards so that the discharging door 12 is open. When the exhausting position sensing sensor 94 senses a discharging operation of the disposable vessel 20, the microcomputer 96 applies an electric power to the fourth driving member 88 in order to return it to the exhausting position (C).

In the preferred embodiment of the present invention, the noodles storing member 30, the vessel supplying part 40, the heating member 50, the vessel conveying part 70, the vessel discharging part 80, the sensing members and the sensing sensors are installed in the main body 10 at one couple as shown in FIG. 1. However, they can be employed at least one element in the main body 10.

The microcomputer 96 of the control part 96 controls the vessel supplying part 40, the heating member 50, the vessel conveying part 70 and the vessel discharging part 80, respectively.

Herein below, operation of the automatic vending machine for noodles according to the present invention will be explained in detail.

If an electric power is applied to the automatic vending machine for noodles, the microcomputer 96 of the control part 90 initializes individual constitutional parts thereof and applies an electric power to the temperature-heating member 64 in order to heat the water contained in the heating tank 67. Due to this heating operation, the temperature of the water raises a predetermined temperature level then the temperature-sensing sensor 65 senses it and thereby a sensing signal is transmitted to the microcomputer 96. When the temperature of the heating-water reaches the predetermined temperature level, the microcomputer 96 shuts off the electric power applied to the temperature-heating member 64. Alternatively, when the temperature of the heating-water is below the predetermined temperature level, the microcomputer 96 applies an electric power to the temperature-heating member 64.

Consequently, it is possible to uniformly maintain the temperature of the heating-water in the heating tank 67 at the predetermined temperature level.

Under this state, when a consumer inserts a predetermined coin or a paper money into the coin-operated mechanism installed at the door 13, an ordering signal is generated from the mechanism. Then, the microcomputer 96 controls individual constitutional parts in order to cook noodles in accordance with the consumer's request.

At this time, if one noodle is ordered, the microcomputer 96 controls one side of the first driving member 42G. Further, if two noodles are ordered, the microcomputer 96 controls both sides of the first driving members 42G simultaneously and respectively. In the present embodiment, the process in which one noodle is ordered, cooked and sold will be explained.

Firstly, when an electric power is applied to the first driving member 42G, it drives the first rotating rod 42E. Thereby, the first rotating plate 42F is rotated in a set angle. Like this, if the first rotating plate 42F is rotated, the rotating angle thereof is sensed. And, the first rod 42E operates the first connecting rod 42D, thereby the first connecting rod 42D pushes up the vessel locating member 42B. At this time, the vessel locating member 42B upwardly slides, in a state that it is in safe condition, by the vertical guiding member 42C.

The vessel locating member 42B, which is upwardly moved due to drive of the first driving member 42G, pushes up the original disposable vessel 20 which its both boundaries are supported by the vessel-supporting link 44B.

That is, plural disposal vessels 20, in which noodles and powdered condiments are contained, are piled. The vessel locating member 42B pushes up the lower portion of the lowest disposal vessel 20, and thereby the whole disposal vessels 20 are moved upwardly.

At this time, both boundaries of the lowest disposal vessel 20 are spaced about 6 mm from the upper surface of the vessel-supporting link 44B.

Like this, the first operating sensing member 91, which senses the rotating angle of the first rotating plate 42F, senses the ascending of the vessel locating member 42B. Further, the microcomputer 96 receiving the sensing signal blocks an electric power to be applied to the first driving member 42G and gets the vessel locating member 42B to stop ascending. That is, if the first operating sensing member 91 senses the set angle of the first rotating plate 42F during rotation of the first rotating plate 42F, an electric power is blocked and the vessel locating member 42B stops to upwardly moving.

Consequently, the microcomputer 96 applies an electric power to the second driving member 46D and rotates the second rotating plate 46B in a set angle so that the second connecting rod 46A pushes the reciprocating link 44D toward the first bracket 44A. Thereby, the vessel-supporting link 44B and the connecting link 44C are opened as shown in FIG. 5c.

At this time, when the vessel supporting link 44B and the connecting link 44C are opened, the whole disposal vessel 20 are supported by the vessel-locating member 42B.

If the rotation of the second plate 46B, that is the opening of the link-operating part 44, is sensed by the second operating sensing member 92 which senses the rotation of the second plate 46B, and if the sensed signal is transferred to the microcomputer 96, the microcomputer 96 applies an electric power to the first driving member 42G again so that the vessel-locating member 42B descends. The descending of the vessel-locating member 42B means the descending of the whole piled disposal vessel 20.

The second operating sensing member 92 senses the rotating angle of the second plate 46B and transfers the signal to the microcomputer 96 during descend of the vessel-locating member 42B. The microcomputer 96 receiving the signal controls the first driving member 42G so that the vessel-locating member 42B descends about 8 mm from the original ascending position, and it rotates the second rotating plate 46B in a set angle, respectively.

By descending the vessel-locating member 42B about 8 mm, next disposal vessel 20 is moved to the original position of the original disposal vessel 20, and it is safely mounted on the vessel-supporting link 44B. So, the original disposal vessel 20 is disconnected from the vessel-supporting link 44B.

If the first operating sensing member 91 senses the descending of the vessel-locating member 42B, the microcomputer 96 receives the sensed signal and applies an electric power to the first driving member 46D so that the first driving member 46D rotates the second rotating plate 46B in a set angle.

When the second rotating plate 46B is rotated, the second rod 46A pulls the reciprocating link 44D, and thereby the opened vessel-supporting link 44B is returned to the original condition.

If the above described operation is sensed by the second operating sensing member 92 which senses the rotating angle and the number of revolutions, the microcomputer 96 applies an electric power to the first driving member 42G and rotates the first rotating plate 42F. (Substantially, the first rotating plate 42F is rotated by the driving of the first rotating rod 42E). Thereby, the vessel-locating member 42B descends in the original condition.

Due to this operation, if the vessel-locating member 42B descends, the original disposal vessel 20 being supported by the vessel-locating member 42B descends in a state that it is safely mounted on the vessel-locating member 42B. However, the next disposal vessel 20 is safely mounted on and supported by the vessel-supporting link 44B having both originally returned boundaries.

Meanwhile, the original disposal vessel 20, which is discharged from the noodles-storing member 30, is downwardly moved by the descending vessel-locating member 42B. And, the vessel 20 is supported by the vessel-supporting member 74 of the vessel conveying part 70 displaced in the original position (A) (the position in which the disposal vessel 20 is safely mounted on the vessel supporting member 74) by being held both ends thereof. Further, the vessel-locating member 42B continuously descends, and it is returned to the original condition.

This series operation is possible since the vessel-locating member 42B ascends while passing through the vessel-supporting member 74 and the vessel-supporting link 44B.

The vessel-locating member 42B passes through the vessel-supporting member 74 and the vessel-supporting link 44B, and it ascends. And then, the vessel-locating member 42B holds the original disposal vessel 20 and passes through the vessel-supporting member 74 during descend thereof. At this time, the vessel-locating member 42B, formed to be smaller than the disposal vessel 20, passes through the vessel-supporting member 74. However, the boundary of the disposal vessel 20 is held by the upper surface of the both sides of the vessel-supporting member 74, and then it is safely mounted.

Consequently, if the vessel locating sensing sensor 98, which is installed on the upper surface of the both sides of the vessel-supporting member 74, senses that both boundaries of the disposal vessel 20 are safely mounted, the microcomputer 96 operates the third driving member 76E. Thereby, the third rotating plate 76C is rotated in a set angle.

If the third rotating plate 76C is rotated, the third and fourth connecting rods 76A and 76B are operated, and the link member 72 is pulled toward the heating member 50.

If the link member 72 is pulled toward the heating member 50, it rotates with respect to the lower side hinge and then the upper portion draws an arc shape. The vessel-supporting member 74 and the upper portion of the link member 72 are pivotally connected with each other. The disposal vessel 20 containing noodles and condiments is safely mounted, and the vessel-supporting member 74 is applied an amount of load. Therefore, the vessel-supporting member 74 is not rotated and sustains in horizontal condition though the transferring link member 72 is rotated toward the heating member 50.

If the third driving member 76E rotates the third rotating plate 76C in a set angle, the bottom surface of the disposal vessel 20 safely mounted on the vessel supporting member 74 is safely mounted on the heating member 50. That is, the disposal vessel 20 is placed on the heating position (B) (the upper surface of the heating member 50).

The microcomputer 96 blocks the electric power being applied to the third driving member 76E, and it gets the vessel-supporting member 74 to continuously be rotated.

If the third operating sensing member 93 senses the above operation, the microcomputer 96 opens the second valve 66 of the hot water supplying part 60 for a set time so that a predetermined amount of hot water is supplied into the disposal vessel 20.

At this time, if the water level of the hot water being sensed by the water level sensor 63 has a lower value than a predetermined one, the microcomputer 96 opens the first valve 61. And then, the water in the storage tank 62 is supplied into the heat tank 67.

Consequently, the microcomputer 96 applies an electric power to the heating member 50 for the set time so that the heating member 50 heats the disposal vessel 20 and then cooks the noodles.

If the timer, not shown, senses that the set time is over, the microcomputer 96 blocks the electric power being applied to the heating member 50 and applies an electric power to the third driving member 76E, so that the third rotating plate 76C is driven.

If the third rotating plate 76C is driven, the link member 72 is rotated in the opposite direction. Thereby, the disposal vessel 20 being safely mounted on the vessel-supporting member 74 is safely mounted on the upper surface of the vessel discharging member 84. That is, the disposal vessel 20 is placed on the discharging position (C) (the upper surface of the vessel discharging member 84).

At this time, the third rotating plate 76C is rotated so that the link member 72 is further moved in a state that the disposal vessel 20 be safely mounted on the upper surface of the vessel discharging member 84.

The vessel-supporting member 74 is further moved toward the upper surface of the vessel discharging member 84 so that the positioning protrusion formed on the bottom surface of both boundaries of the disposal vessel 20 is disconnected from the positioning hole. Thereby, the disposal vessel 20 is easily disconnected from the vessel-supporting member 74.

If the disposal vessel 20 is safely mounted on the upper surface of the vessel discharging member 84, this is sensed by the discharging position sensor 94. And, the microcomputer 96 receiving the sensing signal operates the fourth driving member 88.

If the fourth rotating plate 86 is driven by the operation of the fourth driving member 88, it pushes the fifth connecting rod 86A and gets the vessel discharging member 84 to move toward the discharging hole 11 of the door 13.

At this time, since the front portion of the vessel-supporting member 74 is opened, the disposal vessel 20 is not interfered with the vessel-supporting member 74 and disconnected from the vessel-supporting member 74 even though the vessel discharging member 84 is moved to the discharging hole 11 in a condition in which the disposal vessel 20 is placed on the vessel-supporting member 74.

The vessel discharging member 84 being moved toward the discharging hole 11 by the driving of the fourth rotating plate 86 pushes the discharging door 12 blocking the discharging hole 11 outwardly, and it opens the discharging hole 11. The vessel discharging member 84 is moved toward the discharging hole 11 and fully opens the discharging door 12. At this time, when the outside of the door 13 is exposed, a consumer takes out the disposal vessel 20 containing the cooked noodles.

At this time, the microcomputer 96 gets the fourth driving member 88 to stop operating in a condition in which the vessel discharging member 84 is fully exposed to the outside of the discharging hole 11, so that the vessel discharging member 84 is still exposed to outside of the door 13.

Meanwhile, if the disposal vessel 20 being safely mounted on the vessel discharging member 84 is taken out, this action is sensed by the discharging position sensor 94. And, the sensor 94 transfers the sensed signal to the microcomputer 96. The microcomputer 96 receiving the signal applies an electric power to the fourth driving member 88. And, the fourth driving member 88 drives the fourth rotating plate 86, so that the vessel discharging member 84 is moved into the door 13 and finally returned in the original condition.

At this time, if the vessel discharging member 84 is moved to the main body 10, the discharging door 12 is returned by the elasticity of the spring and blocks the discharging hole 11.

As above described, if the disposal vessel 20 containing the cooked Noodles from the upper surface of the discharging member 84 is taken out, this action is sensed by the vessel position sensor 94. Further, the microcomputer 96 receiving this sensed signal operates the fourth driving member 88 and then drives the fourth rotating plate 86, so that the vessel discharging member 84 is returned in the original condition.

After the vessel discharging member 84 discharges the disposal vessel 20, it is returned. At this time, all elements of the vending machine according to the present invention are in a state in which a coin is inserted in the coiner, an order is input, the noodles is cooked and sold, and finally they stand by taking next order.

Meanwhile, the noodles vending machine according to a preferred embodiment of the present invention further includes the chopsticks throwing device 100 being able to automatically supply chopsticks at the time when the disposal vessel 20 is drawn out.

The chopsticks throwing device 100 includes the seventh bracket 110, the chopsticks receiving member 120, the cutting member 130, the chopsticks supporting member 140, the sixth connecting rod 150, the fifth driving member 160 and the discharging member 170.

The seventh bracket 110 is installed inside of the door 13 and formed with the discharging hole 13A thereon.

The chopsticks receiving member 120 is vertically installed on the seventh bracket 110 so that the opened lower portion thereof is placed on the discharging hole 13A. Also, the chopsticks receiving member 120 has cut holes 122 formed through both sides of the lower portion thereof respectively, and receives the chopsticks 13D packed in the connected wrapping paper.

The cutting member 130 has the cutting blade 134 formed to opposite with each other in the operating hole 132, and is installed on the seventh bracket 110 so that it is moved perpendicularly to the chopsticks 13D by the guiding roller 135.

The chopsticks supporting member 140 is installed on both sides of the bottom surface of the cutting member 130 with a predetermined gap so that it is under the discharging hole 13A, and it supports the chopsticks 13D being downwardly moved.

The sixth connecting rod 150 has one end being is hingedly connected to one side of the cutting member 130.

The fifth driving member 160 is controlled by the controlling part 90 and rotates the fifth rotating plate 162 in setting angle so that the cutting member 130 is moved reciprocally.

And, the discharging member 170 has the slanted surface 172 and is installed on the bottom surface of the seventh bracket 110. So, the chopsticks 13D being discharged from the discharging hole 13A of the seventh bracket 110 is discharged through the chopstick drawn out part 13N formed through the door 13.

The chopsticks 13D being received in the chopsticks receiving member 120 is filed up so that the connecting portion of the wrapping papers is placed in zigzag type. At this time, the whole connecting portions except a portion are cut.

The cutting member 130 is formed with the operating hole 132 on the intermediate thereof so that the chopsticks receiving member 120 can be inserted. The cutting blade 134 is formed to protrude at both inner sides of the operating hole 132. Further, the cutting member 130 is installed on the seventh bracket 110 so that it is reciprocally moved perpendicularly to the longitudinal direction of the chopstick receiving member 120 by the plural guiding roller 135.

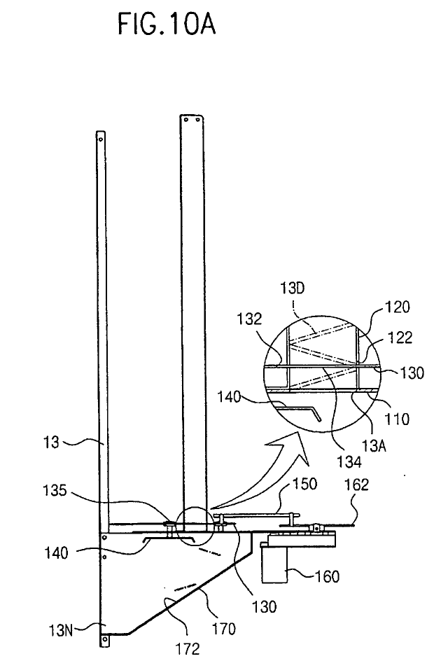

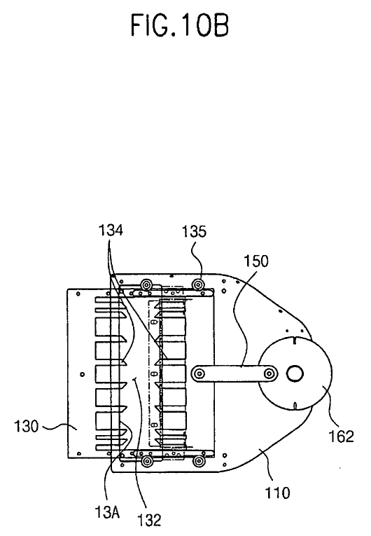

Meanwhile, the chopsticks supporting member 140 is placed on the lower portion of the discharging hole 13A so that it supports the chopsticks 13D being placed on the lowest portion. As shown in FIG. 10, the chopsticks supporting member 140 is installed so that both sides thereof are downwardly slanted respectively, and both ends thereof are the same as the receiving direction of the chopsticks 13D. Therefore, the chopsticks supporting member 140 is moved together with the cutting member 130.

Both ends of the chopsticks supporting member 140 deviate from the both sides of the seventh bracket 110 and are connected to the cutting member 130 by the bolt etc., or the hole are formed on both sides of the seventh bracket 110. Further, the chopstick supporting member 140 is installed on the cutting member 130 through the hole, and it is reciprocally moved together with the cutting member 130.

The fifth driving member 160 is installed on the bottom surface of one side of the seventh bracket 110, and it drives the fifth rotating plate 162 installed on the upper surface thereof. The sixth connecting rod 150 has one end being pivotally installed on the fifth rotating plate 162 and the other end being pivotally installed on the cutting member 130. Therefore, if the fifth rotating plate 162 is rotated, the sixth connecting rod is moved and then the cutting member 130 is reciprocally moved.

At this time, the fifth operating sensing member to sense the rotating angle of the fifth rotating plate 162 is installed on the seventh bracket 110, so that the fifth driving member 160 is controlled by the microcomputer 96.

The chopsticks throwing device 100 having above described construction operates as follows. As shown in FIG. 10, the chopsticks throwing device 100 is controlled by the microcomputer 96. That is, it is preferable that the chopsticks throwing device 100 is operated at the time after and before the vessel discharging member 84 is moved toward the discharging door 12.

The operating process of the chopsticks throwing device 100 will be described.

Firstly, if the microcomputer 96 generates the operating signal and an electric power is applied to the fifth driving member 160, the fifth driving member 160 is operated and drives the rotating plate 162. Thereby, the sixth connecting rod 150 pushes the cutting member 130.

As like this, if the cutting member 130 is pushed by the sixth connecting rod 150, it is moved to the reverse direction of the fifth rotating plate 162. Thereby, the cutting blade 134 of the fifth rotating plate 162 is inserted into the cutting hole 132, and it cuts the connecting portion of the wrapping paper of the chopsticks 13D. At this time, as shown in FIG. 10, the chopsticks supporting member 140 supports the lower portion of the lowest chopsticks 13D, which will be cut, whereby the connecting portion of the wrapping paper is in “<” type. This type of cutting portion is cut while the cutting blade 134 is inserted into the cutting hole of the other side, whereby the original chopstick 13D and the next one are separated.

The original chopstick separated like above drops down through the discharging hole 13A. Afterward, it is guided to the slanted surface 172 of the discharging member 170, and it is discharged to the chopstick throwing part 13N of the door 13.

At this time, the microcomputer 96 blocks the power being applied to the fifth driving member 169 and gets the fifth rotating plate 162 to stop rotating. Further, when the microcomputer 96 receives the discharging signal, it applies an electric power to the fifth driving member 160, so that the fifth rotating plate 162 is rotated and thereby the cutting member 130 is moved to it.

When the cutting member 130 is moved to the reverse direction of the original moving direction, the cutting blade 134 of the other side is inserted into the cutting hole and cuts the connecting portion between the next chopstick 13D and the after next chopstick 13D. Thereby, the chopstick connected by the wrapping paper may be separated and discharged.

That is, each chopstick 13D connected with each other in zigzag type is orderly separated by the cutting member 130 and is discharged.

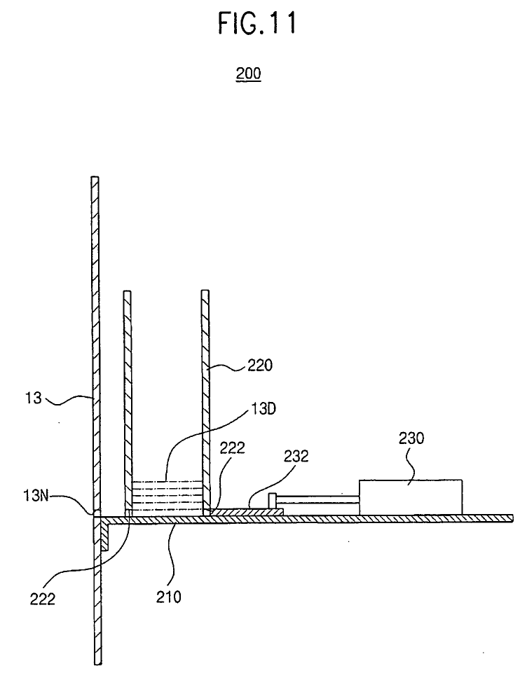

Meanwhile, the chopstick throwing device 200 according to the another preferred embodiment, as shown in FIG. 11, includes the eighth bracket 210, the chopstick saving member 220 and the sixth driving member 230.

The eighth bracket 210 is installed on the inner side of the door 12.

The chopstick keeping member 220 is fixed installed on the eighth bracket 210, so that the moving hole 222 is formed on the both lower sides and then it is placed on the chopstick throwing part 13N formed on the door 13.

The sixth driving member 230 is installed on one side of the eighth bracket 210, gets the discharging rod 232 being inserted into the moving hole 222 to reciprocally move. Further, the sixth driving member 230 pushes the chopstick 13D filed on the chopstick saving member 220 and moves the chopstick 13D to the taking out part 13N.

The moving hole 222 is preferably formed to have the size, which is little bigger than the thickness of the chopstick 13D, so that the saved chopstick 13D is discharged each piece.

The sixth driving member is a solenoid in the present embodiment, however it may be an air cylinder, a motor and so on without limit.

The operating process of the chopstick throwing part 200 according to the present embodiment will be described referring to FIG. 11.

As shown in FIG. 11, the microcomputer 96 of the control part 90 generates the signal for throwing a chopstick. The sixth driving member 230 pulls the operating rod (the operating rod is moved toward the chopstick saving member). Thereby, the discharging rod 232 is inserted into the moving hole 222.

If the discharging rod 232 is inserted into the moving hole 222, the lowest chopstick 13D is pushed to the taking out part 13N by the discharging rod 232 and then a portion thereof is exposed to outside of the door 13.

Consequently, the operating rod, which gets the discharging rod 232 to move, is returned, in the original condition, by the elasticity of the spring, and then it moves the discharging rod 232 to the original position.

As like this, if a portion of the original chopstick 13D is exposed to outside of the door 13, the chopstick 13D is taken out.

Like this process, after the chopstick 13D is discharged, the next chopstick 13D is moved the lower portion of the chopstick saving member 220 and stands by the next operation.

Since the chopstick 13D is discharged following to each vessel of noodles in each piece, it can be comfortably used. Further, comparing with the case in which the chopstick is left alone, it can greatly save the consumption of the chopstick.

The present invention is not limited within the chopstick throwing device according to the above described embodiments, but it is enough whether the chopstick may be discharged in piece.

According to the noodles vending machine of the present invention, noodles is cooked in a disposal vessel, and the disposal vessel itself is directly transferred to the consumer. Therefore, noodles may be cooked sanitarily.

Further, since the noodles keeping die for piling vessels of noodles, the condiments keeping die for containing the condiments and the vessel keeping die and so on are not required, the structure of the vending machine may be simple. And, thereby the vending machine has greatly diminished volume, and it can be light and small.

Further, since the electronic heater is used as a heating means for cooking the noodles, the noodles may be safely cooked.

Further, since the vending machine is provided with the chopstick throwing device, it can be used comfortably, and the number of the manager to handle the vending machine can be diminished.

While the present invention has been particularly shown and described with reference to particular embodiments thereof, it will be understood by those skilled in the art that various changes in form and details may be effected therein without departing from the spirit and scope of the invention as defined by the appended claims.

1. An automatic vending machine for noodles, which automatically cooks noodles by receiving an ordering signal when a predetermined coin is inserted into a coin-operated mechanism, characterized by comprising:
a main body 10 having a door 13 rotatably installed at an open front portion thereof, a middle partition 15 and a lower partition 16 which are installed in the main body 10 and are parallel with each other therein, in which a discharging hole 11 is formed through a one side of the door 13 and may be open or closed by a discharging door 12, and in which a through hole 14 is formed through a one side of the middle partition 15;
a noodles storing member 30 for storing a plurality of metal disposable vessels 20 therein being installed at an inner upper portion of the main body 10 so that an open lower portion thereof is located above the through hole 14, in which noodles to be cooked and dressing materials are contained in the metal disposable vessels 20;
a vessel supplying part 40 for discharging the metal disposable vessels 20 loaded in the noodles storing member 30 one by one being is installed at the central partition 15 so that it is located between the through hole 14 and the noodles storing member 30;
a vessel conveying part 70 for transferring the metal disposable vessels 20 being installed at the lower partition 16, in which the vessel conveying part 70 transfers the metal disposable vessel 20, which is discharged from the vessel supplying part 40, from an initial position (A) to a heating position (B), which is set on an upper surface of the heating member 50, when noodles has been cooked by pouring a hot-water into the metal disposable vessel 20 and by directly heating the metal disposable vessel 20 using the heating member 50, the vessel conveying part 70 transfers the metal disposable vessel 20 from the heating position (B) to an exhausting position (C);
a vessel discharging part 80 for discharging the metal disposable vessel 20, which is transferred to the exhausting position (C) due to operation of the vessel conveying part 70, to the outside through the discharging hole 11 of the discharging door 12, the vessel discharging part 80 being installed at a front portion of the vessel conveying part 70; and
a control part 90 for controlling the vessel supplying part 40, the vessel conveying part 70, the hot-water supplying part 60, the heating member 50 and the vessel discharging part 80 by receiving sensing signals generated from sensing means which senses operational states of the vessel supplying part 40, the vessel conveying part 70 and the vessel discharging part 80 and senses the temperature of the hot-water supplied from the hot-water supplying part 60.

2. The automatic vending machine for noodles according to claim 1, wherein the hot-water supplying part 60 is installed in the main body 10, the hot-water supplying part 60 comprises:
a storage tank 62 for storing water supplied from an outer water source;
a heating tank 67 for heating water introduced from the storage tank 62;
a first valve 61 for controlling introduction of water from the storage tank 62 to the heating tank 67 being installed between the storage tank 62 and the heating tank 67;
a plurality of water level sensing sensor 63 for repeatedly sensing the level of water supplied from the storage tank 62 being installed in the heating tank 67;
a hot-water heating member 64 for heating water supplied from the storage tank 62 being installed in the heating tank 67;
a temperature sensing sensor 65 for sensing the temperature of water heated by the heating tank 67; and
a second valve 66 for controlling discharge of hot-water heated by the hot-water heating member 64 into the metal disposable vessel 20 located on the heating member 50, the second valve 66 being controlled by the control part 90.

3. The automatic vending machine for noodles according to claim 1, wherein the vessel supplying part 40 comprises:
a link-operating part 44 including a pair of vessel-supporting links 44B, a pair of connecting links 44C, a reciprocating link 44D, and a first horizontal guiding member 44F, in which ends of the vessel-supporting links 44B are hingedly coupled with both sides of the first bracket 44A installed at the middle partition 15, both ends of the disposable vessel 20 are located over the vessel-supporting links 44B, the ends of the connecting links 44C are hingedly connected with the vessel-supporting links 44B, the other ends of the connecting links 44C are hingedly connected with both sides of the reciprocating link 44D, the first horizontal guiding member 44F for guiding the reciprocating link 44D in order to slide the reciprocating link 44D in the horizontal direction is installed at the middle partition 15;
a discharging part 46 for operating the link-operating part 44 including a second connecting rods 46A, a second rotating plate 46B, and a second driving member 46D, in which one end of the second connecting rods 46A is coupled with the reciprocating link 44D, the other end of the second connecting rods 46A is coupled with the second rotating plate 46B and the center thereof is eccentric to the second rotating plate 46B, the second rotating plate 46B is installed at the middle partition 15 by means of a third bracket 46C, the second driving member 46D for driving the second rotating plate 46B is installed at the third bracket 46C and is controlled by the control part 90; and
a vessel-supporting part 42 including a discharging supporting bracket 42A, a vessel-locating member 42B, a first connecting rod 42D, a first rotating rod 42E, a first rotating plate 42F, and a first driving member 42G, in which the discharging supporting bracket 42A is installed at the lower partition 16 so that it is located below the lower portion of the through hole 14, the vessel-locating member 42B can slide through a space created between the legs of the vessel-supporting link 44B upwards and downwards by a vertical guiding member 42C, the vertical guiding member 42C is installed in the discharging supporting bracket 42A, in which one end of the first connecting rod 42D is connected with the vessel-locating member 42B, the other end of the first connecting rod 42D is connected with one end of the first rotating rod 42E, the first driving member 42G for driving the first rotating plate 42F in order to move the vessel-locating member 42B in the vertical direction is installed at the lower partition 16 and is controlled by the control part 90.

4. The automatic vending machine for noodles according to claim 1, wherein the vessel conveying part 70 comprises:
a pair of link members 72 having lower ends hingedly coupled with a pair of fourth brackets 72A, respectively, in which the fourth brackets 72A are installed on the upper surface of the lower partition 16 so that they are located at the lower part of the through hole 14;
a vessel-supporting member 74 having an open one side and lower sides hingedly coupled with the upper ends of the link members 72, in which the edge of the disposable vessel 20 transferred from the vessel supplying part 40 is snugly seated thereon and then it is supported;
a vessel transferring driving part 76 including a third connecting rods 76A, a second rotating rod 76B, a third rotating plate 76C and a third driving member 76E, in which one end of the third connecting rods 76A is coupled with the link member 72, the other end of the third connecting rods 76A is coupled with on end of the second rotating rod 76B, the other end of the second rotating rod 76B is coupled with the third rotating plate 76C, in which the third driving member 76E is installed at the lower partition 16 by means of the fifth bracket 76D, the third driving member 76E operates the second rotating rod 76B in order to move the vessel-supporting member 74 from the initial position (A) to the heating position (B), from the heating position (B) to the discharging position (C), and from the discharging position (C) to the initial position (A), with maintaining the horizontal state of the vessel-supporting member 74.

5. The automatic vending machine for noodles according to claim 1, wherein the vessel discharging part 80 comprises;
a second horizontal guiding member 82 being installed at an upper portion of a sixth bracket 82A, in which the sixth bracket 82A is installed at a front part of the lower partition 16 so that it is located at the lower portion of the exhausting position (C);
a vessel-discharging member 84 being installed on an upper surface of the second horizontal guiding member 82, in which the metal disposable vessel 20 transferred to the exhausting position (C) due to operation of the vessel conveying part 70 may be seated on the vessel-discharging member 84;
a fourth rotating plate 86 being rotatably coupled with one end of a fifth connecting rod 86A of which the other end is rotatably coupled with the vessel discharging member 84; and
a fourth driving member 88 for moving the fourth rotating plate 86 being installed at a one side of the sixth bracket 82A and being controlled by the control part 90, in which the vessel discharging member 84 moves toward the discharging hole 11 of the discharging door 12 with maintaining its horizontal state due to movement of the fourth rotating plate 86 driven by the fourth driving member 88.

6. The automatic vending machine for noodles according to claim 3, wherein the vertical-guiding member 42C and the first horizontal guiding member 44F comprise a cylindrical bearing (BE) and guiding rods (RD) slidably coupled with the bearing (BE), respectively.

7. The automatic vending machine for noodles according to claim 3, wherein the vertical-guiding member 42C and the first horizontal guiding member 44F comprise an outer case (OCA) and an internal case(ICA), in which the internal case (ICA) can slide in the longitudinal direction by a plurality of bearings received in the outer case (OCA).

8. The automatic vending machine for noodles according to claim 5, wherein the second horizontal guiding member 82 comprises two pair of discharging link members 82B, in which low ends of the discharging link members 82B are hingedly coupled with both upper sides of a sixth bracket 82A and upper ends of the discharging link members 82B are hingedly coupled with both lower sides of the vessel discharging member 84.

9. The automatic vending machine for noodles according to claim 5, wherein the second horizontal-guiding member 82 comprises an outer case 82C fixed to the upper surface of the sixth bracket 82A, and an outer case 82D which slides in the longitudinal direction by means of a plurality of ball bearings received in the outer case 82C.

10. The automatic vending machine for noodles according to claim 1, wherein the control part 90 comprises:
a first operating sensing member 91 for sensing operation of the vessel-locating member 42B;
a second operating sensing member 92 for sensing operation of the vessel-supporting link 44B;
a vessel locating sensing sensor 98 being installed at both side surfaces of the vessel-supporting member 74, the vessel locating sensing sensor 98 sensing a stable location of the disposable vessel 20 transferred by the vessel-locating member 42B such that edges of the disposable vessel 20 locates on edges of the vessel-supporting member 74;
a third operating sensing member 93 for sensing operation of the vessel-supporting member 74;
an exhausting position sensing sensor 94 being installed at the vessel discharging member 84, the exhausting position sensing sensor 94 sensing a stable location of the disposable vessel 20 onto the vessel discharging member 84;
a fourth operating sensing member 95 for sensing operation of the vessel discharging member 84; and
a microcomputer 96,
wherein the microcomputer 96 applies an electric power to the first driving member 42G when a coin inserting signal is generated from a coin-operated mechanism, the disposable vessels 20 are moved upwards due to ascending of the vessel-locating member 42B, when the first operating sensing member 91 senses an operation of the vessel-locating member 42B, the microcomputer 96 applies an electric power to the second driving member 46D in order to widen the space provided between the legs of the vessel-supporting link 44B, when the second operating sensing member 92 senses an operation of the vessel-supporting link 44B, the microcomputer 96 applies an electric power to the first driving member 42G in order to downwardly move and then to stop the vessel-locating member 42B, the microcomputer 96 applies an electric power to the second driving member 46D in order to return the vessel-supporting link 44B to its initial position so that next disposable vessel 20 is locked in the vessel-supporting link 44B, when the second operating sensing member 92 senses the operation of the vessel-supporting link 44B, the microcomputer 96 applies an electric power to the first driving member 42G in order to downwardly move the vessel-locating member 42B to its initial position, and thereby the primary disposable vessel 20 is located on the vessel-supporting member 74, when the vessel locating sensing sensor 98 senses a stable loading of the disposable vessel 20, the microcomputer 96 applies an electric power to the first driving member 92F in order to return the vessel-locating member 92B to its initial position, the microcomputer 96 applies an electric power to the third driving member 76E in order to move the vessel-supporting member 74 from the initial position (A) to the heating position (B), when the third operating sensing sensor 93 senses an operation of the vessel-supporting member 74, the microcomputer 96 applies an electric power to the second valve 66 in order to open it for a predetermined time interval, when a predetermined quantity of hot-water is poured into the disposable vessel 20, the microcomputer 96 applies an electric power to the heating member 50 for a predetermined time interval in order to heat the disposable vessel 20, after passing the predetermined time interval, the microcomputer 96 applies an electric power to the third driving member 76E in order to move the disposable vessel 20 from the heating position (B) to the exhausting position (C) and to return its initial position by means of the vessel-supporting member 74 in a state that the disposable vessel 20 maintains its horizontal state, when the exhausting position sensing sensor 94 senses a stable loading of the disposable vessel 20, the microcomputer 96 applies an electric power to the fourth driving member 88 in order to move the vessel discharging member 84 toward the discharging hole 11, and thereby the vessel discharging member 84 pushes the discharging door 12 outwards so that the discharging door 12 is open, when the exhausting position sensing sensor 94 senses a discharging operation of the disposable vessel 20, the microcomputer 96 applies an electric power to the fourth driving member 88 in order to return it to the exhausting position (C).

11. The automatic vending machine for noodles according to claim 10, wherein the first, the second, the third and the fourth operating sensing members 91,92, 93,95 comprise a limit switch, respectively.

12. The automatic vending machine for noodles according to claim 10, wherein the first, the second, the third and the fourth operating sensing members 91,92, 93,95 comprise a photo coupler for sensing a rotating angle of the first, the second, the third and the fourth rotating plates 42E, 46B, 76C, 86, respectively.

13. The automatic vending machine for noodles according to claim 1, wherein the door 13 is provided with a chopsticks throwing device 100 comprising:
a seventh bracket 110 being installed inside of the door 13, in which a discharging hole 13A is formed there through;
a chopsticks receiving member 120 for receiving the chopsticks 13D packed in the connected wrapping paper being vertically installed on the seventh bracket 110 so that the opened lower portion thereof is placed on the discharging hole 13A, in which cut holes 122 are formed through the lower both sides of the chopsticks receiving member 120;
a cutting member 130 having cutting blades 134 formed to opposite with each other in an operating hole 132 formed at the center of the cutting member 130, and being installed on the seventh bracket 110 so that it is moved perpendicularly;
a chopsticks supporting member 140 for supporting the chopsticks 13D being downwardly moved, the chopsticks supporting member 140 being installed on both sides of the bottom surface of the cutting member 130 with a predetermined gap so that it is under the discharging hole 13A;
a sixth connecting rod 150 of which a one end is hingedly connected to one side of the cutting member 130;
a fifth driving member 160 being controlled by the controlling part 90 and rotating the fifth rotating plate 162 in setting angle so that the cutting member 130 is moved reciprocally; and
a discharging member 170 having a slanted surface 172 and being installed on the bottom surface of the seventh bracket 110, in which the chopsticks 13D being discharged from the discharging hole 13A of the seventh bracket 110 is discharged through the chopstick drawn out part 13N formed through the door 13.

14. The automatic vending machine for noodles according to claim 1, wherein the door 13 is provided with a chopsticks throwing device 100 comprising:
an eighth bracket 210 being installed on the inner side of the door 13;
a chopstick saving member 220 being fixed installed on the eighth bracket 210, in which moving holes 222 are formed on both lower sides of the chopstick saving member 220 and then it is placed on a chopstick throwing part 13N formed on the door 13; and
a sixth driving member 230 being installed on one side of the eighth bracket 210, the sixth driving getting the discharging rod 232 being inserted into the moving hole 222 to reciprocally move, and it pushing the chopstick 13D filed on the chopstick saving member 220 and moving the chopstick 13D to the taking out part 13N.

15. The automatic vending machine for noodles according to claim 14, wherein the sixth driving member 230 comprises a solenoid.
